(19) United States
(12) Patent Application Publication
(10) Pub. No.: US 2013/0175769 A1
(43) Pub. Date: Jul. 11, 2013

(54) COMBINATION TOOL HOLDER

(71) Applicants: Wen-Yung YANG, Taichung City (TW); Yuan-Ho Lin, Taichung City (TW); Feng-Chi Shen, Taichung City (TW)

(72) Inventors: Wen-Yung YANG, Taichung City (TW); Yuan-Ho Lin, Taichung City (TW); Feng-Chi Shen, Taichung City (TW)

(21) Appl. No.: 13/347,291

(22) Filed: Jan. 10, 2012

(51) Int. Cl. B23B 31/10

(52) U.S. Cl. 279/105.1

(57) ABSTRACT

A combination tool holder includes a holder body, at least one tool adapter and a bolt. The holder body defines therein a through hole including an enlarged-diameter segment, a reduced-diameter segment and a tapered segment. A stepped surface is formed between the enlarged-diameter segment and the reduced-diameter segment. The tool adapter defines therein a channel and has a combining end. The combining end has a conical surface configured to be received in the tapered segment. The bolt includes a screw and a nut. The nut is configured to abut against the stepped surface while the screw extends into the tapered segment to engage with the combining end. By screwing the bolt, the conical surface is driven to press against the tapered segment, making the through hole and the channel coaxial.

### BACKGROUND OF THE INVENTION

1. Technical Field

The present invention relates to tool holders for machine tools, and more particularly to a combination tool holder having a detachable tool adapter.

2. Description of Related Art

In a machine tool, there is typically a tool holder for convenient replacement of tools.

Some existing tool holders implement the principle of thermal expansion/contraction to hold a tool firmly in a gripping hole. Since such a tool holder is subject to repeated heating, it is desired to be made of metal or alloy, which is unlikely to be structurally destroyed under repeated heating. However, such metal or alloy may be expansive.

With the attempt to lower the material costs, some combination tool holders have been developed. For example, a “thermal-expansion tool holder” as disclosed in Taiwan Patent No. TW M284478 has a tool holder composed of a tool holder base for a machine tool to hold and a noble-metal portion for gripping a tool. The noble-metal portion is attached to one end of the tool holder base through a friction welding process. Although such a design is effective in reducing the use of noble metal, the manufacturing inconveniently involves friction welding. In addition, once combined, the tool holder base and noble-metal portion can not be separated from each other. This is also a defect.

As an improvement, Taiwan Patent No. TW M326871 has proposed a “combination tool holder”. Instead of friction welding, its tool holder base and noble-metal portion are combined in a screwing manner. This is achieved by internal threads formed in the tool holder base and external threads formed on the noble-metal portion that allow the tool holder base and noble-metal portion to be screwed with each other. As it is of importance to ensure the noble-metal portion and the tool holder base are coaxially assembled, Taiwan Patent No. TW M326871 incorporates plural screws and fasteners to provide fine positional adjustment to the noble-metal portion.

While the important coaxial alignment between the tool holder base and noble-metal portion is achieved in the prior-art device, the plural screws need repeated operations before the desired alignment is accomplished, and this is also an inconvenience.

Hence, there is at least a need for a combination tool holder with convenient alignment.

### SUMMARY OF THE INVENTION

The primary objective of the present invention is to provide a combination tool holder with convenient alignment.

To this end, according to the present invention, a combination tool holder comprises a holder body having a flange for a machine tool to grip and defining therein a through hole extending along an axis of the holder body, the through hole including an enlarged-diameter segment, a reduced-diameter segment and a tapered segment, the reduced-diameter segment located between the enlarged-diameter segment and the tapered segment, and a stepped surface formed between the enlarged-diameter segment and the reduced-diameter segment; at least one tool adapter defining therein a channel extending along an axis of the tool adapter, each said tool adapter having a combining end and a working end opposite to the combining end, the combining end having a conical surface configured to be received in the tapered segment, the conical surface and the tapered segment being made based on an identical taper, the channel having a threaded portion corresponding to the combining end and a gripping portion corresponding to the working end, and the gripping portion being configured to, when heated, allow a tool to be inserted therein, and, after cooled, grip the tool in position; a bolt including a screw and a nut, the bolt being configured to be placed into the through hole through the enlarged-diameter segment, and the nut being configured to abut against the stepped surface while the screw extends into the tapered segment and engages with the threaded portion of the combining end, wherein by screwing the bolt, the conical surface is driven to press against the tapered segment, making the through hole and the channel coaxial.

With the configuration as described above, the present invention allowing screwing the bolt to make the conical surface press against the tapered segment. Since the tapered segment and the conical surface follow the same taper, this operation also achieves coaxial alignment of the holder body and the tool adapter. Thereby, assembling the tool holder can be conveniently and rapidly.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of a combination tool holder according to one preferred embodiment of the present invention;

FIG. 2 is an exploded view of the combination tool holder of FIG. 1;

FIG. 3 is a cross-sectional view of the combination tool holder of FIG. 1;

FIG. 3A is a partial, enlarged view of the combination tool holder according to FIG. 3; and

FIG. 4 through FIG. 5 are applied views of the combination tool holder of FIG. 1; and

FIG. 6 is an applied view of a combination tool holder according to another preferred embodiment of the present invention.

### DETAILED DESCRIPTION OF THE INVENTION

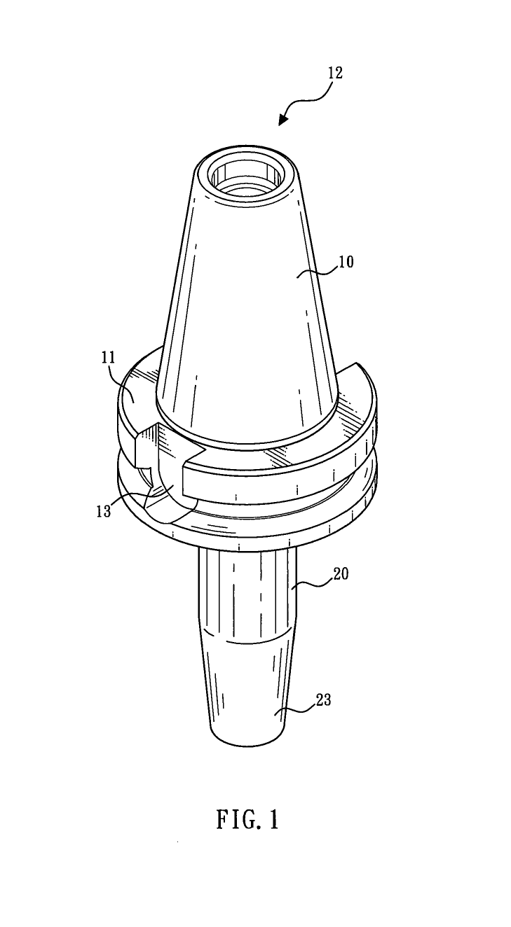

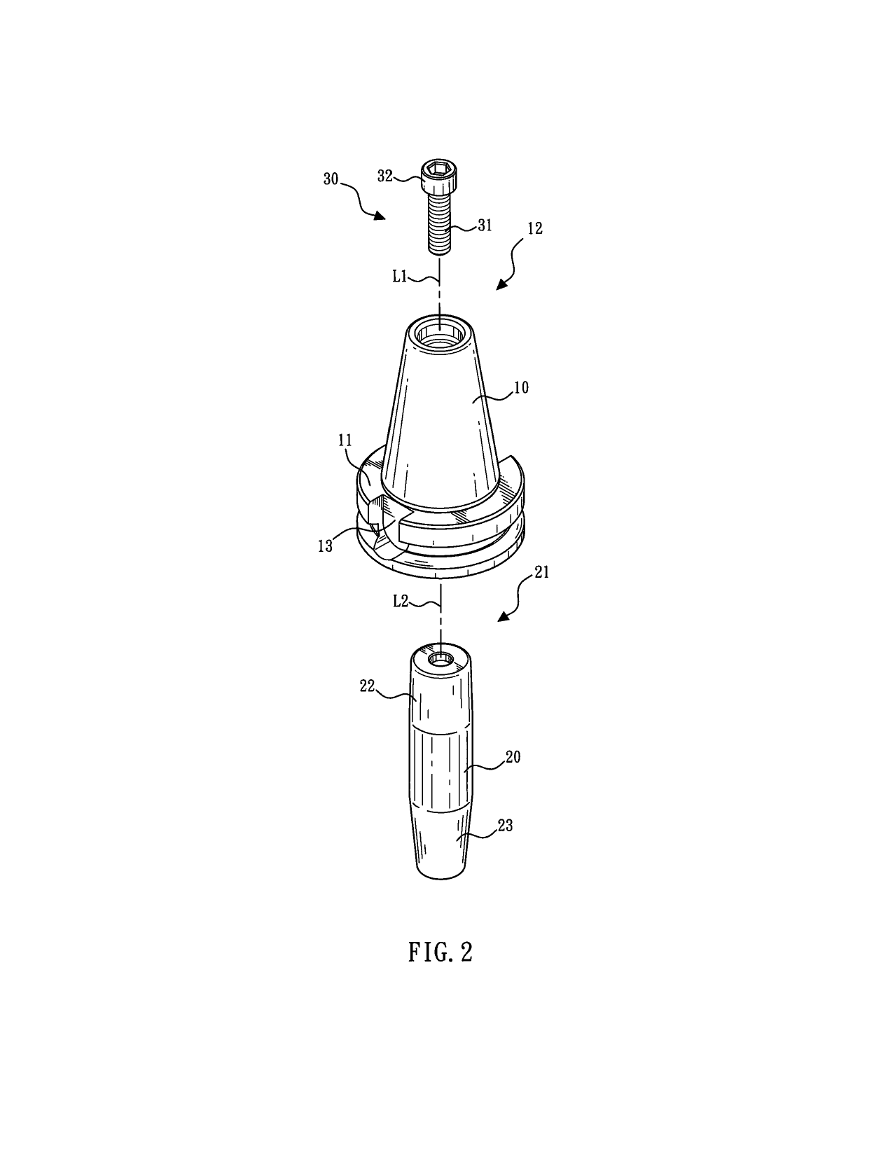

Referring to FIG. 1 through FIG. 3, according to one preferred embodiment of the present invention, a combination tool holder comprises a holder body 10, at least one tool adapter 20 and a bolt 30.

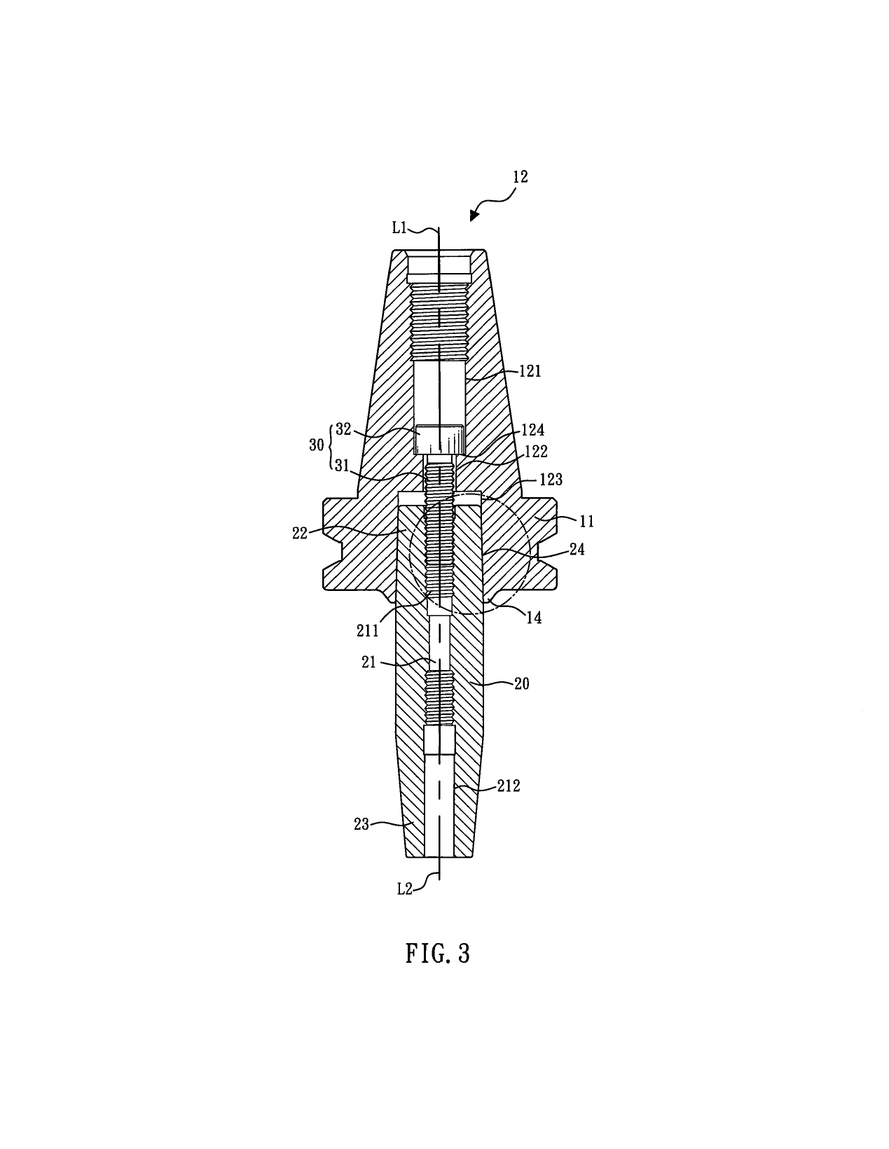

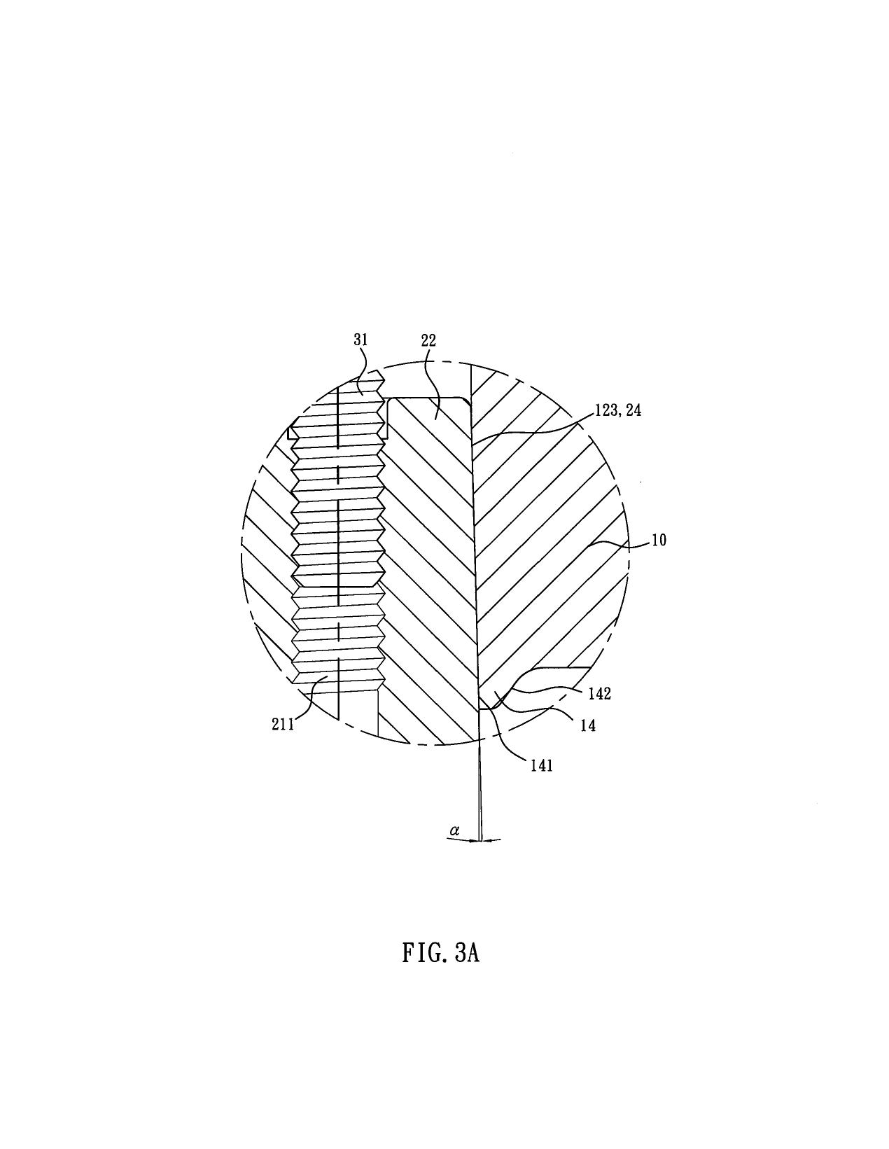

The holder body 10 is provided with a flange 11 for a machine tool (not shown) to hold, and a through hole 12 passing through the holder body 10 along an axis Li of the holder body 10. Preferably, the flange 11 is provided with at least one positioning notch 13 for the machine tool to use and thereby position the combination tool holder. The through hole includes an enlarged-diameter segment 121, a reduced-diameter segment 122 and a tapered segment 123. The reduced-diameter segment 122 is located between the enlarged-diameter segment 121 and the tapered segment 123 such that a stepped surface 124 is formed between the enlarged-diameter segment 121 and the reduced-diameter segment 122. Preferably, the holder body 10 further has an annular rim 14 surrounding an opening of the tapered segment 123, for strengthening the tapered segment 123 at the opening and resisting stress. Further referring to FIG. 3A, the annular rim 14 particularly includes an abutting surface 141 and a positive camber 142. The abutting surface 141 is configured to fittingly embrace a combining end 22 of the tool adapter 20. The positive camber 142 is connected between the abutting surface 141 and the flange 11. Thereby, during operation of a tool as described below, a force transferred to the holder body 10 by the tool adapter 20 can be distributed evenly, so as to prevent the tapered segment 123 cracking at the opening due to excessive stress.

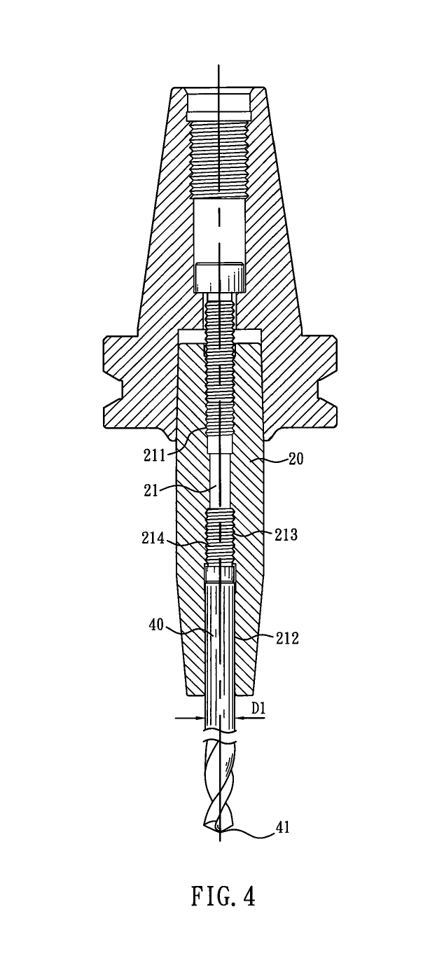

The tool adapter 20 defines therein a channel 21 extending along an axis L2 thereof. The tool adapter 20 also includes a working end 23 opposite to the combining end 22. The combining end 22 has a conical surface 24 configured to be received in the tapered segment 123. Further referring to FIG. 3A, the conical surface 24 and the tapered segment 123 are formed according to the same taper a. The channel 21 has a threaded portion 211 corresponding to the combining end 22 and has a gripping portion 212 corresponding to the working end 23. The gripping portion 212 is configured to, when heated, receive a tool 40 (as shown in FIG. 4) and, after cooled, grip the tool 40 in position. Since the tool adapter 20 is subject to repeated heating and therefore thermal expansion/contraction that allows assembling/disassembling of the tool 40, it is desired to be made of metal or alloy, which is unlikely to be structurally destroyed under repeated heating. As such metal or alloy can be expansive, for minimizing the manufacturing costs, the tool adapter 20 and the holder body 10 may be made of different materials. In other words, it is desired that the holder body 10 is made of a material less expensive than the metal or alloy forming the tool adapter 20, so as to limit the overall material costs for making the combination tool holder.

The bolt 30 is composed of a screw 31 and a nut 32. The bolt 30 is placed into the through hole 12 through the enlarged-diameter segment 121. The nut 32 is configured to abut against the stepped surface 124, while the screw 31 extends to the tapered segment 123 and engages with the threaded portion 211 of the combining end 22 in a screwing manner. As the bolt 30 is screwed, the conical surface 24 is driven to press against the tapered segment 123, thereby making the channel 21 coaxial with the through hole 12, or making the axes L1, L2 substantially coincident.

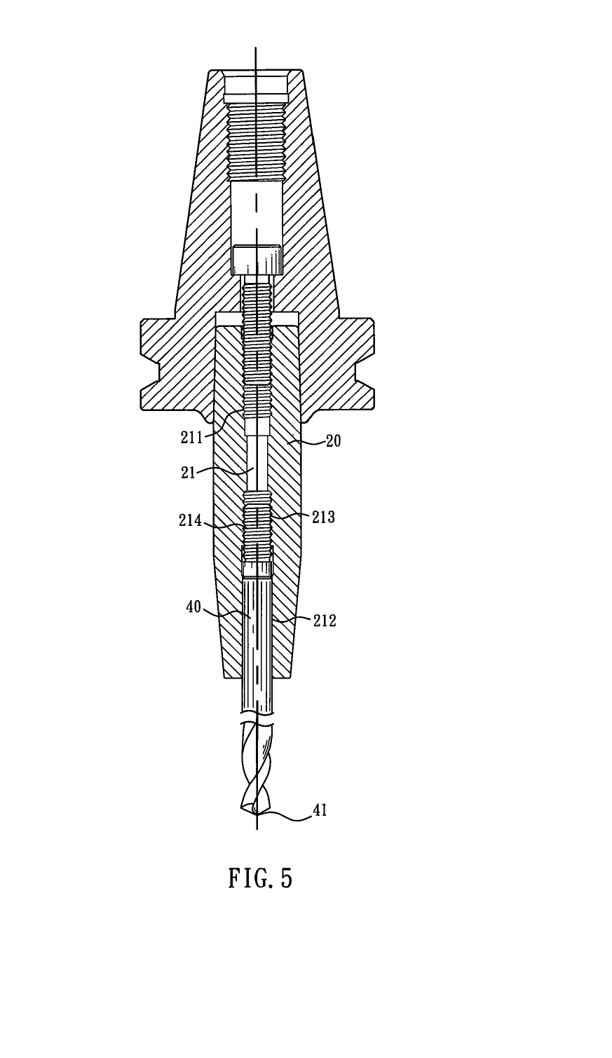

Now referring to FIG. 4 and FIG. 5, the channel 21 of the tool adapter 20 further has an adjusting portion 213 and an adjusting screw 214. The adjusting portion 213 is located between the threaded portion 211 and the gripping portion 212. The adjusting portion 213 is at least one partially formed with threads, so that the adjusting screw 214 is allowed to screwed within the adjusting portion 213. Thereby, as the adjusting screw 214 goes deeper into the adjusting portion 213, the tool 40 goes deeper into the gripping portion 212, and vice versa. In such a manner, a free end 41 of the tool 40 can be adjusted with respect to the combination tool holder.

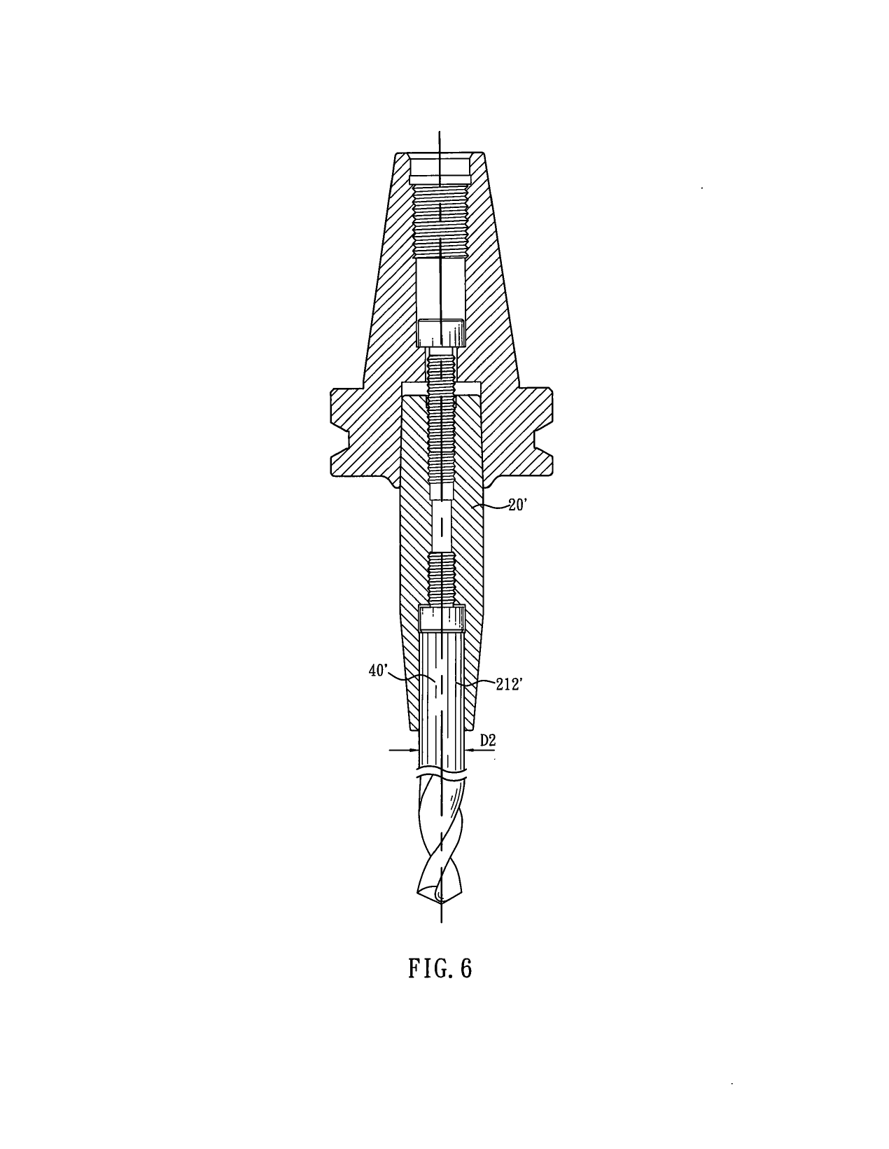

Now referring to FIG. 6, in an alternative embodiment of the present invention, the combination tool holder, in addition to the tool adapter 20 as described above, may further have one or more tool adapters 20′. In other words, the tool adapters 20, 20′ may come in plurality, and the holder body 10 may selectively combine with any of the tool adapters 20, 20′. In such a case, the tool adapters 20, 20′ preferably have their gripping portions 212, 212′ different in diameter. As shown in FIG. 4 and FIG. 6, for instance, the gripping portion 212 has a diameter D1 while the gripping portion 212′ has a diameter D2, wherein D2 is greater than Dl. This design allows the combination tool holder to adapt to the tools 40, 40′ of different sizes.

As discussed previously, the holder body and the tool adapter of the present invention are provided with the tapered segment and the conical surface, respectively, so that as the holder body and the tool adapter are increasingly screwed with each other, the conical surface can increasingly press against the tapered segment. In addition, since the conical surface and the tapered segment follow the same taper, when the conical surface properly presses against the tapered segment, the coaxial alignment therebetween can be achieved without using a lateral screw member as used in TW M326871. Therefore, the present invention not only simplifies the structure of the subject matter by minimizing the number of components required, but also provides convenient yet reliable coaxial alignment between the tool adapter and the holder body, thereby meeting the needs existing in the art.

What is claimed is:

1. A combination tool holder, comprising:
a holder body defining therein a through hole extending along an axis of the holder body, the through hole including an enlarged-diameter segment, a reduced-diameter segment and a tapered segment, the reduced-diameter segment located between the enlarged-diameter segment and the tapered segment, and a stepped surface formed between the enlarged-diameter segment and the reduced-diameter segment;
at least one tool adapter defining therein a channel extending along an axis of the tool adapter, each said tool adapter having a combining end and a working end opposite to the combining end, the combining end having a conical surface configured to be received in the tapered segment, the conical surface and the tapered segment being made based on an identical taper, the channel having a threaded portion corresponding to the combining end and a gripping portion corresponding to the working end, and the gripping portion being configured to, when heated, allow a tool to be inserted therein, and, after cooled, grip the tool in position;
a bolt including a screw and a nut, the bolt being configured to be placed into the through hole through the enlarged-diameter segment, and the nut being configured to abut against the stepped surface while the screw extends into the tapered segment and engages with the threaded portion of the combining end, wherein by screwing the bolt, the conical surface is driven to press against the tapered segment, making the through hole and the channel coaxial.

2. The combination tool holder of claim 1, wherein the combination tool holder comprises a plurality of tool adapters, and the holder body selectively combine with one of the tool adapters, in which the gripping portions of different tool adapters are different in diameter.

3. The combination tool holder of claim 1, wherein the tool adapter and the holder body are made of different materials.

4. The combination tool holder of claim 1, wherein the holder body comprises a flange for a machine tool to hold, and the flange has at least one positioning notch for the machine tool to use and thereby position the combination tool holder.

5. The combination tool holder of claim 1, wherein the holder body further comprises an annular rim surrounding an opening of the tapered segment, the annular rim including an abutting surface and a positive camber, the abutting surface being configured to fittingly embrace the combining end, and the positive camber being connected between the abutting surface and the flange.

6. The combination tool holder of claim 1, wherein the channel further comprises an adjusting portion and an adjusting screw, the adjusting portion located between the threaded portion and the gripping portion, the adjusting portion being at least one partially formed with threads, the adjusting screw being configured to be screwed into the adjusting portion, whereby as the adjusting screw goes deeper into the adjusting portion, the tool is allowed to go deeper into the gripping portion, and vice versa.
